(19) United States
(12) Patent Application Publication
(10) Pub. No.: US 2018/0137776 A1
(43) Pub. Date: May 17, 2018

(54) Contextual Nutrition Intake Recommendation Based on Athlete's Physical Activity

(71) Applicant: International Business Machines Corporation, Armonk, NY (US)

(72) Inventors: Katie M. Farrer, Avon, CO (US); Arthur J. Meloy, Washington, DC (US); Aaron J. Quirk, Cary, NC (US)

(21) Appl. No.: 15/350,248

(22) Filed: Nov. 14, 2016

(51) Int. Cl. G09B 19/00; G09B 5/02; A63B 24/00

(52) U.S. Cl. CPC G09B 19/0092; G09B 5/02; A63B 24/0062; A63B 2220/78; A63B 2220/72; A63B 2220/75; A63B 2230/425; A63B 2230/505; A63B 2230/085; A63B 2230/062; A63B 2220/30; A63B 2230/015; A63B 2230/705; A63B 2220/22

(57) ABSTRACT

An approach is provided in which an information handling system receives an input data set corresponding to a physical activity of a user and determines a nutrition intake recommendation for the user. In turn, the information handling system provides the nutrition intake recommendation to the user prior to the user completing the physical activity.

### BACKGROUND

The present disclosure relates to providing nutrition intake recommendations to a user in context with the user's upcoming physical activities for the user to maintain an optimal performance level during the physical activity.

Endurance athletes often train and compete on unfamiliar courses typically spanning long distances and taking several hours to complete, such as running courses, cycling courses, cross-country courses, etc. As such, it is imperative for an athlete to consume nutrition during the physical activity to maintain performance throughout an event. The nutrition may come from sports nutrition products such as high-electrolyte drinks, energy bars, gels etc. In order for the nutrition to be effective, the athlete should consume the nutrition at optimal times of the physical activity. Do to the fact that the athlete may be unfamiliar with a particular course, the athlete may be unaware of an upcoming section in the course that requires an adjustment to the user's nutrition, such as a steep uphill climb, sandy terrain, humid conditions, and etcetera.

### BRIEF SUMMARY

According to one embodiment of the present disclosure, an approach is provided in which an information handling system receives an input data set corresponding to a physical activity of a user and determines a nutrition intake recommendation for the user. In turn, the information handling system provides the nutrition intake recommendation to the user prior to the user completing the physical activity.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing a real-time nutrition recommendation system receiving an input data set corresponding to a user's upcoming physical activity and providing contextual nutritional intake recommendations to the user so the user may consume the recommended nutrition in advance of the upcoming physical activity;

FIG. 4 is an exemplary diagram showing nutrition information utilized by a real-time nutrition recommendation system to provide recommendations to a user;

FIG. 5 is an exemplary flowchart showing steps taken to configure a real-time nutrition recommendation system;

FIG. 6 is a diagram depicting a real-time nutrition recommendation system receiving course information and segmenting the course into zones based on terrain and/or other environmental factors; and

FIG. 7 is an exemplary flowchart showing steps taken by an information handling system to provide real-time nutrition intake recommendations to a user based on upcoming physical activities.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

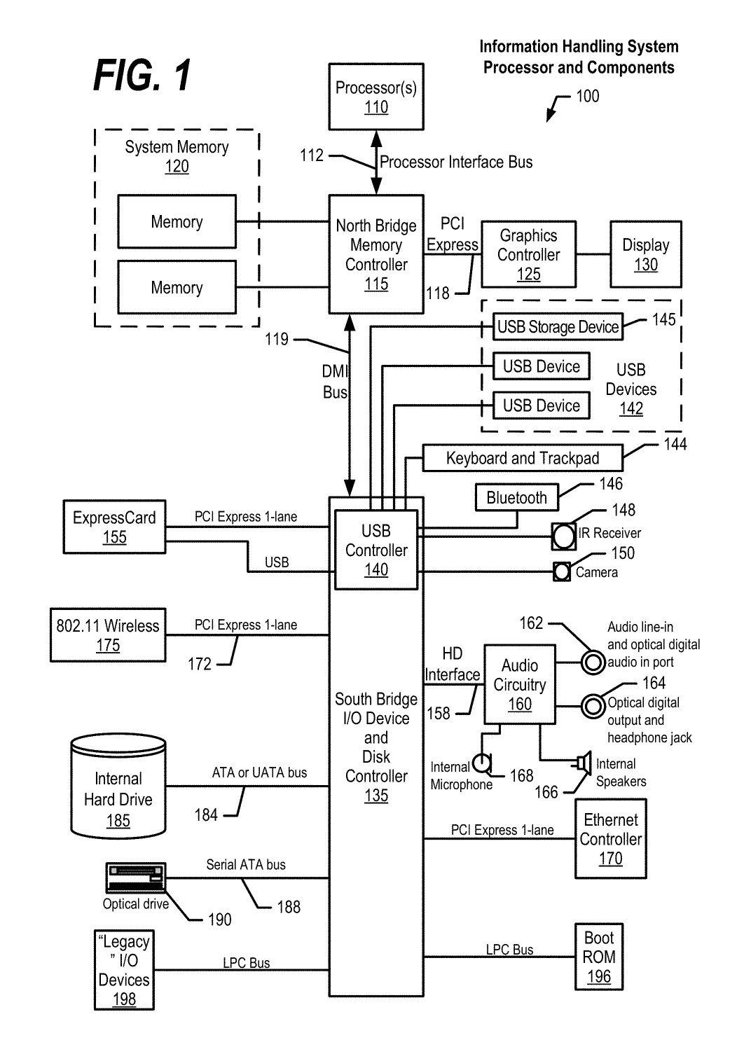

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

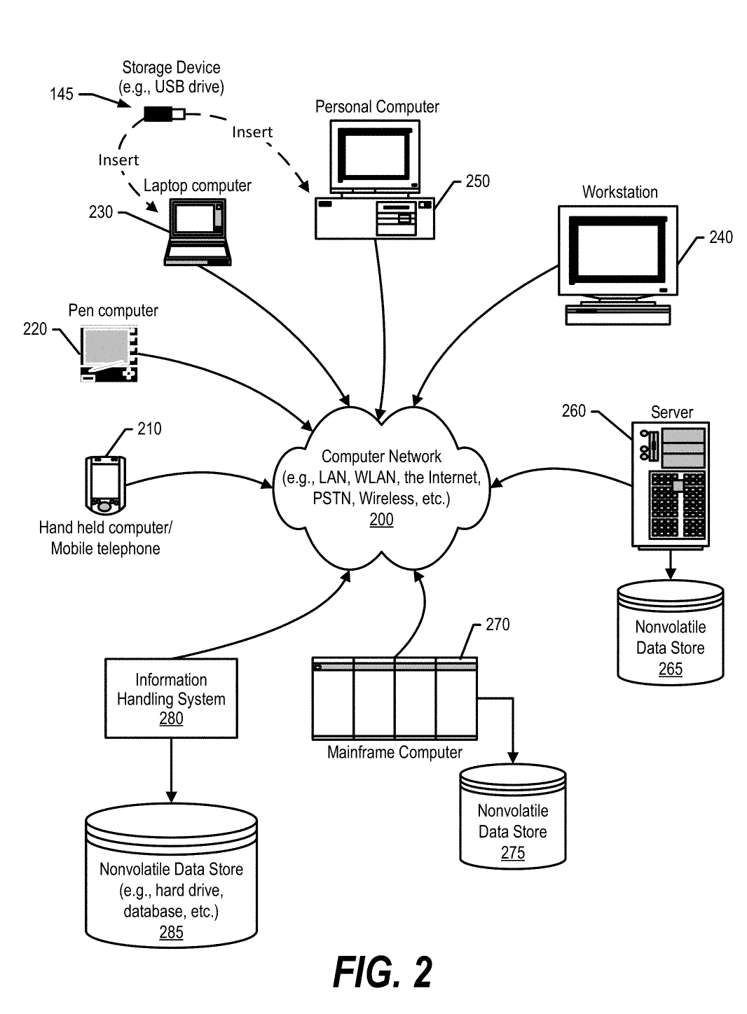

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

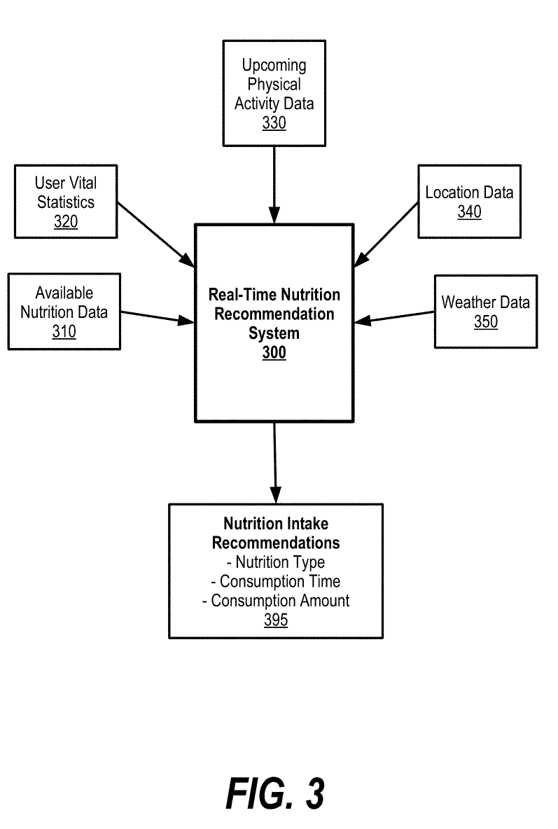

FIGS. 3 through 7 depict an approach that can be executed on an information handling system. The information handling system provides nutrition intake recommendations to a user at points in time during a physical activity that allows sufficient time for the nutrition to be ingested into the user's system. As discussed earlier, a user might not be aware when to consume nutrition because of factors such as unknown terrain conditions or weather conditions. The information handling system combines knowledge of upcoming course, terrain, weather, vital statistics, and other environmental conditions to provide a nutrition intake recommendation. In one embodiment, the nutrition intake recommendation is based on available nutrition to the user, such as fluids and food included in the user's backpack.

Some embodiments of the present invention may include one, or more, of the following features, characteristics, advantages and/or operations: (i) receiving, by a machine logic device, an input data set of information related to timing of nutrition intake when a first user's is performing an athletic performance; (ii) analyzing, by the machine logic device, the input data set to determine a nutritional timing recommendation that includes information relating to a recommended timing of nutritional intake by the first user; (iii) during the performance of the athletic performance, sending, by the machine logic device and to a first user interface hardware set, the nutritional timing recommendation; (iv) communicating, through the first user interface hardware set and to the first user in human understandable form and format, the nutritional timing recommendation; (v) the machine logic device is included in a portable computing device carried by the first user during performance of the athletic performance; (vi) the first user interface hardware set is included in the portable computing device (vii) the input data set includes information indicative of at least one of the following: weather, terrain, stride length, exertion rate, body movement frequency, bodily moisture, body temperature, brainwaves, pulse rate, historical nutritional intake, historical athletic performance data, speed, body weight, body mass index, mechanical shock data, breathing rate and/or body chemistry data (eg, pH of a region of the first user's body); (viii) receiving, by a machine logic device and from a biometric sensing device carried by a first user, a biometric input data set of information related to timing of nutrition intake when a first user's is performing an athletic performance; (ix) analyzing, by the machine logic device, the input data set to determine a nutritional timing recommendation that includes information relating to a recommended timing of nutritional intake by the first user; (x) during the performance of the athletic performance, sending, by the machine logic device and to a first user interface hardware set, the nutritional timing recommendation; (xi) the input data set includes information indicative of at least one of the following: stride length, exertion rate, body movement frequency, bodily moisture, body temperature, brainwaves, pulse rate, historical nutritional intake of the first user, speed, body weight, body mass index, mechanical shock data, breathing rate and/or body chemistry data (e.g., pH of a region of the first user's body); (xii) machine logic to collect what type of nutrition the user has and uses machine logic rules to make specific recommendations for when and what nutrition (e.g., hydration) should be consumed based upon triggers like weather, terrain data, or course conditions, etc.; and/or (xiii) use of sweat strips to help make nutritional recommendations during an athletic performance.

FIG. 3 is a diagram showing a real-time nutrition recommendation system receiving an input data set corresponding to a user's upcoming physical activity and providing contextual nutritional intake recommendations to the user so the user may consume the recommended nutrition in advance of the upcoming physical activity.

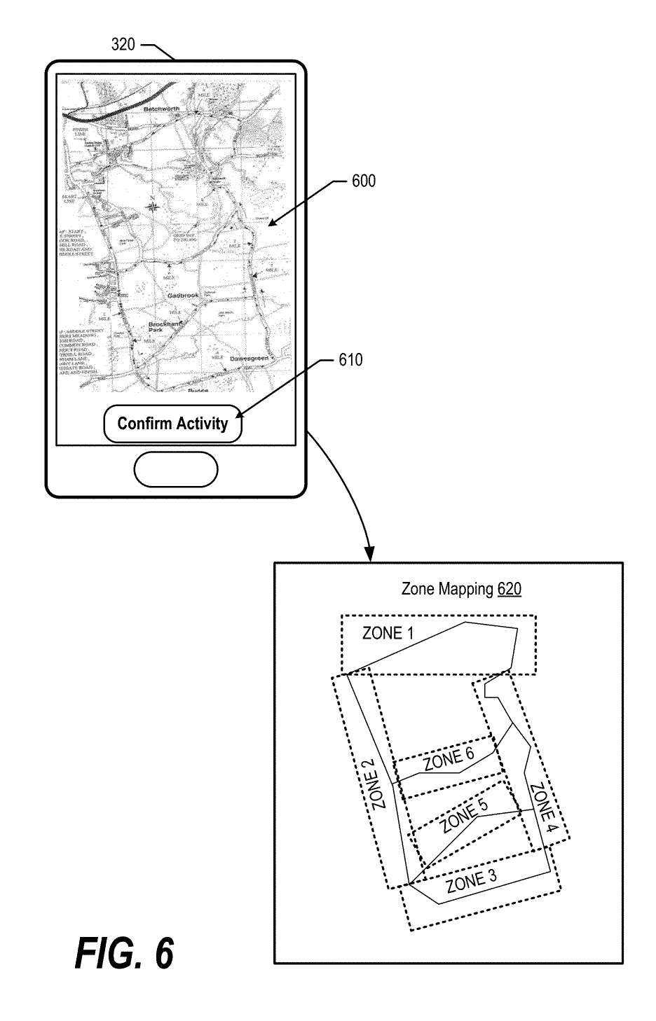

In one embodiment, the upcoming physical activity may be a long distance course and real-time nutrition recommendation system 300 segments the long distance course into zones based on terrain, upcoming weather forecasts, etc. (see FIG. 6 and corresponding text for further details). For example, real-time nutrition recommendation system 300 may segment a marathon into flat zones, uphill zones, shaded zones, sunny zones, etc., and may also adjust the zones based on the current and upcoming weather conditions. In this embodiment, real-time nutrition recommendation system 300 analyzes each zone and provides nutrition intake recommendations for an upcoming zone to a user prior to the user reaching the zone.

Real-time nutrition recommendation system 300 receives upcoming physical activity data 330 that may include course information (start, stop, waypoints, start time, a webpage link to an endurance event, etc.), whether the upcoming physical activity is indoor or outdoor, the type of physical activity (running, biking, kayaking, swimming, cross training, etc.). Real-time nutrition recommendation system 300, in one embodiment, also receives available nutrition data 310 from the user that indicates the type of nutrition and amount of nutrition that the user has available. In this embodiment, the user may scan a barcode on the nutrition's package and real-time nutrition recommendation system 300 uses the barcode to determine the nutrition type, amount, and nutrient content. In another embodiment, real-time nutrition recommendation system 300 automatically searches a database to determine the nutrient content such as the caloric value, proportion of protein, fat, and carbohydrates as well as the electrolytes in each food and beverage entered. If the food or beverage is not found in the database, the user may be prompted to enter its caloric value, proportion of protein, fat, and carbohydrates, and electrolytes.

Real-time nutrition recommendation system 300 may also receive user vital statistics 320 such as the user's weight, height, gender, optional heart rate zones, etc. In one embodiment, if the user does not enter in their heart-rate zones, real-time nutrition recommendation system 300 automatically generates heart-rate zones based upon age and gender.

Real-time nutrition recommendation system 300 monitors the physical activity using data such as location data 340 and weather data 350. For example, the user may be on a running course and a steep uphill section is ½ mile away. In this example, real-time nutrition recommendation system 300 analyzes available nutrition data 310, user vital statistics 320, the terrain relative to location data 340, and weather data 350 to determine nutrition intake recommendations 395. For example, if the user has been in a hard heart rate zone for a prolonged duration for longer than 5 minutes and a steep uphill grade is approaching, real-time nutrition recommendation system 300 may recommend a high caloric beverage or food prior to the uphill grade to provide the user with increased energy. In another example, if the temperature is hot or the humidity is high, real-time nutrition recommendation system 300 may recommend a beverage every 30 minutes. In yet another example, if the upcoming terrain is rocky, muddy, slippery, sandy, etc., which requires more energy to traverse, real-time nutrition recommendation system 300 may recommend a high caloric beverage or food to provide the user with increased energy. In yet another example, if the ambient trail temperature is in direct sunlight for over 20 minutes, real-time nutrition recommendation system 300 may recommend frequent beverage intakes.

In one embodiment, the user configures real-time nutrition recommendation system 300 to provide and receive information in a non-intrusive manner because the user may not be able to view a display on real-time nutrition recommendation system 300. In this embodiment, the user may configure real-time nutrition recommendation system 300 to vibrate a certain amount of times for each 12 ounces of fluid the user should consume and the user may shake real-time nutrition recommendation system 300 when the user consumes fluid or food according to nutrition intake recommendations 395.

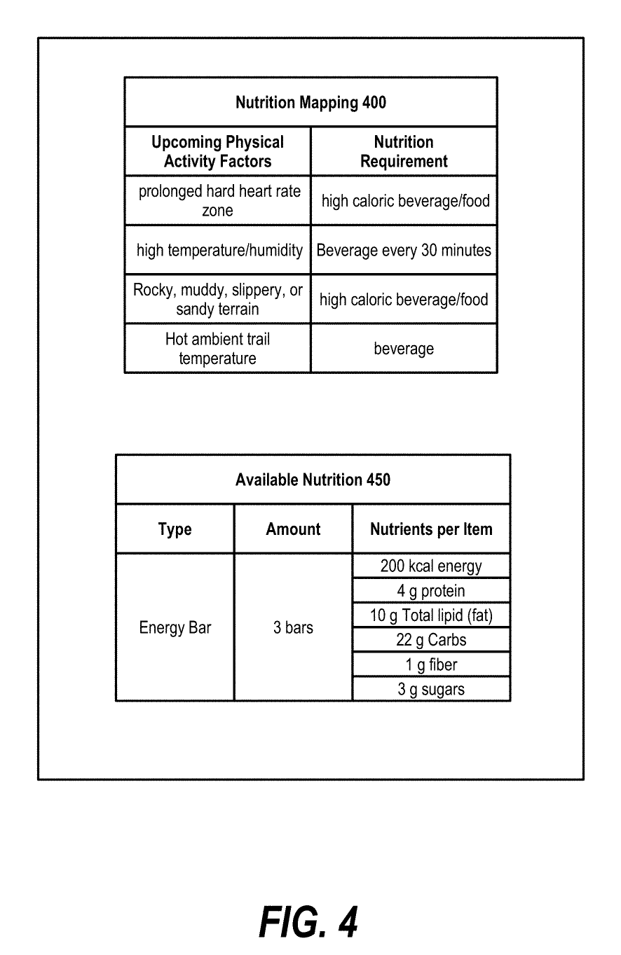

FIG. 4 is an exemplary diagram showing nutrition information utilized by real-time nutrition recommendation system 300 to provide recommendations to a user. Real-time nutrition recommendation system 300 may utilize nutrition mapping 400 to match upcoming physical activities to nutrition requirements. For example, when real-time nutrition recommendation system 300 identifies an upcoming rocky terrain, real-time nutrition recommendation system 300 uses nutrition mapping 400 to determine that a high caloric beverage and/or food is required.

Real-time nutrition recommendation system 300 then uses available nutrition 450 to complete the nutrition intake recommendation. In one embodiment, available nutrition 450 includes a type and amount of available nutrition and nutrients contained within the available nutrition. Real-time nutrition recommendation system 300, in one embodiment, may download the nutrient information from a website, such as from the U.S. Department of Agriculture or the manufacturer's website, and store the nutrient information in a local storage area.

Real-time nutrition recommendation system 300 selects the type and amount of available nutrition to recommend based on the nutrition requirement from nutrition mapping 400. For example, when real-time nutrition recommendation system 300 detects an upcoming rocky terrain, real-time nutrition recommendation system 300 may determine that 200 kilocalories are the optimal amount of nutrition the user should consume and, therefore, recommends that the user consume one energy bar because each bar includes 200 kilocalories.

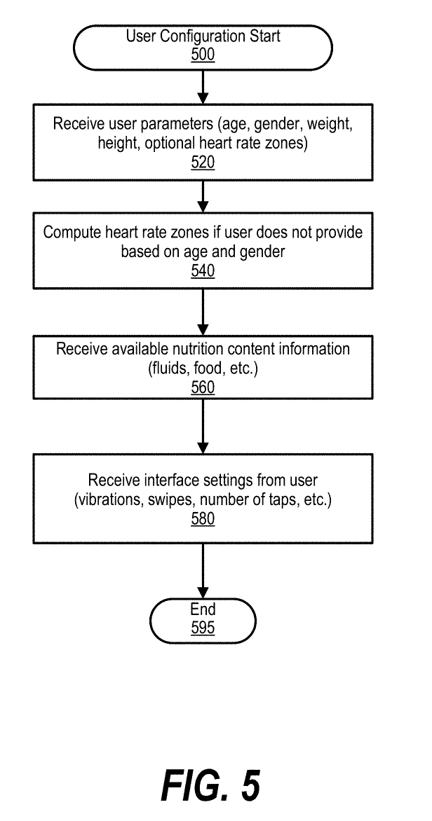

FIG. 5 is an exemplary flowchart showing steps taken to configure a real-time nutrition recommendation system. FIG. 5 processing commences at 500 whereupon, at step 520, the process receives user vital statistics from a user. For example, the user vital statistics may include the user's age, gender, weight, height, optional heart rate zones, etc. At step 540, in one embodiment where the user does not provide heart rate zones in step 520, the process computes customized heart rate zones using the user's parameters such as age and gender.

At step 560, the process receives available nutrition information such as an amount of fluid and type (water, energy drink, recovery drink, etc.) as well as the amount of food and type. In one embodiment, the user may input the name and amount of nutrition and the process accesses a database to identify the nutritional information (amount of calories, sodium, protein, etc.)

At step 580, the process receives interface settings from the user. For example, the user may not be able to check a display or hear audio during the physical activity. As such, the user may configure the real-time nutrition recommendation system 300 to vibrate a certain number of times (e.g., 1 vibration per four ounces of fluid to consume) and also configure the user response settings as to how the use will inform the real-time nutrition recommendation system that the user consumed the recommended nutrition (e.g., a swipe or tap on the display or shaking the real-time nutrition recommendation system). FIG. 5 processing thereafter ends at 595.

FIG. 6 is a diagram depicting a real-time nutrition recommendation system receiving course information and segmenting the course into zones based on terrain and/or other environmental factors such as shade, direct sun, etc. In one embodiment, real-time nutrition recommendation system 320 may display map 600 and the user may select a course's start location, waypoints, and end location. The user may then depress button 610 to confirm the course information. In another embodiment, the user may download course information from a website that includes course information.

In one embodiment, real-time nutrition recommendation system 320 evaluates the course and segments the course into zones as shown in zone mapping 620 (zone 1, zone 2, zone 3, zone 4, zone 5, and zone 6). The zones may be based on terrain such as uphill sections, muddy sections, etc. The zones may also be based on weather factors such as sunny areas, shady areas, or upcoming weather forecasts. For example, clouds may be present at the beginning of a race at an 8:00 AM start time, but the weather forecast predicts an 80% chance of sunshine at 9:00 AM. In this example, real-time nutrition recommendation system 320 determines a zone corresponding to at time at which the clouds are absent relative to a predicted location of user on the course based on, for example, previous pace times of the user. For example, if the user runs a 10 minute mile, real-time nutrition recommendation system 300 determines that the user should be 6 miles into the course at 9:00 AM. As a result, real-time nutrition recommendation system 300 is able to recommend a nutrition intake prior to the user reaching the zone corresponding to the forecasted time of the sunshine.

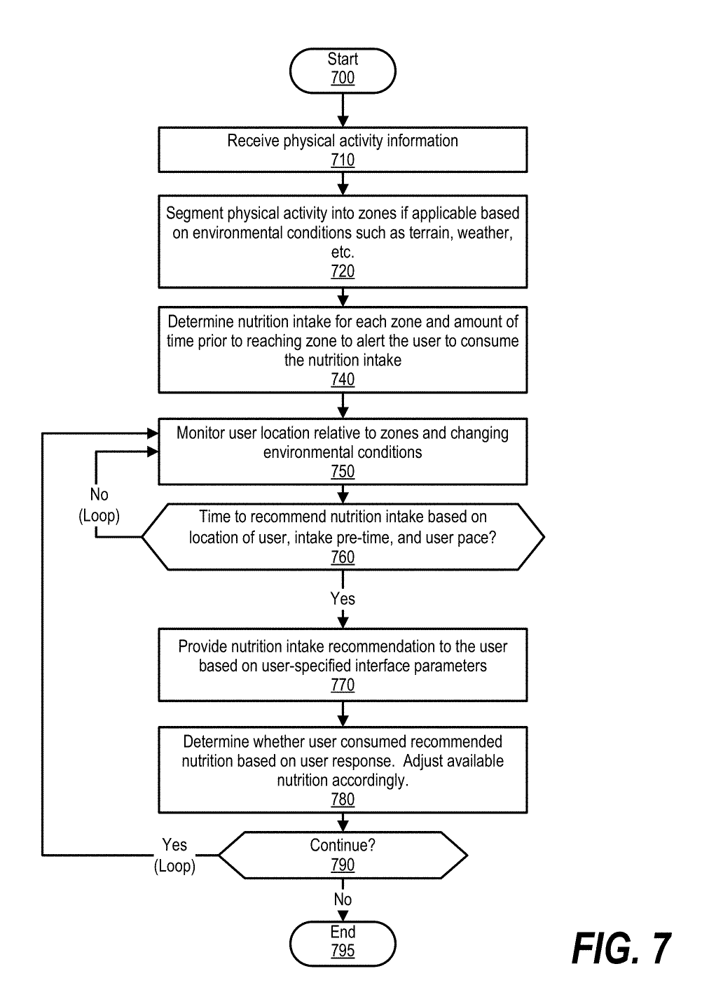

FIG. 7 is an exemplary flowchart showing steps taken by an information handling system to provide real-time nutrition intake recommendations to a user based on upcoming physical activities. FIG. 7 processing commences at 700 whereupon, at step 710, the process receives physical activity information, such as course information. At step 720, in one embodiment, the process segments the upcoming physical activity into zones if applicable based on factors such as terrain, weather, etc.

At step 740, the process determines nutrition intake recommendations, which may include a recommended nutrition type, a recommended consumption amount, and a recommended consumption time. For example, “zone 4” may be a steep uphill climb and the process determines that 16 ounces of a high caloric beverage are required 20 minutes prior to the user reaching zone 4.

At step 750, the process monitors the user's location relative to the upcoming physical activity (upcoming zones) and determines whether it is time to inform the user of a nutrition intake recommendation (decision 760). If it is not time to recommend a nutrition intake, then decision 760 branches to the ‘no’ branch which loops back to continue to monitor the user's location relative to the upcoming physical activity. This looping continues until the real-time nutrition recommendation system should inform the user of a nutrition intake recommendation, at which point decision 760 branches to the ‘yes’ branch exiting the loop. At step 770, the process provides a nutrition intake recommendation to the user according to the user-specified interface parameters (vibration, beep, etc.). At step 780, the process determines whether the user followed the nutrition intake recommendation and consumed the nutrition based on a user response such as a tap, swipe, etc., and adjusts the available nutrition accordingly.

The process determines as to whether to continue (decision 790). If the process should continue, then decision 790 branches to the ‘yes’ branch which loops back to continue monitoring the user's progress and providing nutrition intake recommendations. This looping continues until the process should terminate, such as at the end of a race, at which point decision 790 branches to the ‘no’ branch exiting the loop. FIG. 7 processing thereafter ends at 795.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
receiving an input data set corresponding to a physical activity of a user;
determining a nutrition intake recommendation based on the input data set; and
providing the nutrition intake recommendation to the user prior to the user completing the physical activity.

2. The method of claim 1 wherein the nutrition intake recommendation includes a nutrition type and a nutrition amount, the method further comprising:
determining a nutrition requirement based on the input data set;
collecting nutrient content data corresponding to nutrition available to the user; and
selecting the nutrition type and the nutrition amount based on comparing the nutrition requirement against the nutrient content data.

3. The method of claim 2 further comprising:
adjusting an amount of the nutrition available to the user based on receiving a response from the user indicating that the user performed the nutrition intake recommendation.

4. The method of claim 1 wherein the physical activity is a course and the input data set corresponds to the course, and wherein, during the physical activity, the method further comprising:
identifying an upcoming change in terrain in the course based on the input data set;
determining a point in time that the user will reach the upcoming change in terrain;
computing a recommended consumption time to consume the nutrition intake recommendation based on the point in time; and
notifying the user of the nutrition intake recommendation at the recommended consumption time.

5. The method of claim 1 wherein at least a portion of the input data set is environmental data corresponding to an environment of the physical activity and selected from the group consisting of weather data and terrain data.

6. The method of claim 1 wherein at least a portion of the input data set is biometric input data corresponding to the user and selected from the group consisting of stride length data, an exertion rate data, a body movement frequency data, bodily moisture data, body temperature data, brainwave data, pulse rate data, speed data, body weight data, body mass index data, mechanical shock data, breathing rate data, and body chemistry data.

7. The method of claim 1 further comprising:
receiving interface parameters from the user that indicate a way in which the user requests to interface with the information handling system;
providing the nutrition intake recommendation to the user according the interface parameters; and
receiving a response from the user according to the interface parameters.

8. The method of claim 7 wherein the interface parameters are selected from the group consisting of a vibration parameter, a swipe parameter, and a tap number parameter.

9. An information handling system comprising:
one or more processors;
a memory coupled to at least one of the processors; and
a set of computer program instructions stored in the memory and executed by at least one of the processors in order to perform actions of:
receiving an input data set corresponding to a physical activity of a user;
determining a nutrition intake recommendation based on the input data set; and
providing the nutrition intake recommendation to the user prior to the user completing the physical activity.

10. The information handling system of claim 9 wherein the nutrition intake recommendation includes a nutrition type and a nutrition amount, and wherein at least one of the one or more processors perform additional actions comprising:
determining a nutrition requirement based on the input data set;
collecting nutrient content data corresponding to nutrition available to the user; and
selecting the nutrition type and the nutrition amount based on comparing the nutrition requirement against the nutrient content data.

11. The information handling system of claim 10 wherein at least one of the one or more processors perform additional actions comprising:
adjusting an amount of the nutrition available to the user based on receiving a response from the user indicating that the user performed the nutrition intake recommendation.

12. The information handling system of claim 9 wherein the physical activity is a course and the input data set corresponds to the course, and wherein, during the physical activity, at least one of the one or more processors perform additional actions comprising:
identifying an upcoming change in terrain in the course based on the input data set;
determining a point in time that the user will reach the upcoming change in terrain;
computing a recommended consumption time to consume the nutrition intake recommendation based on the point in time; and
notifying the user of the nutrition intake recommendation at the recommended consumption time.

13. The information handling system of claim 9 wherein at least a portion of the input data set is environmental data corresponding to an environment of the physical activity and selected from the group consisting of weather data and terrain data.

14. The information handling system of claim 9 wherein at least a portion of the input data set is biometric input data corresponding to the user and selected from the group consisting of stride length data, an exertion rate data, a body movement frequency data, bodily moisture data, body temperature data, brainwave data, pulse rate data, speed data, body weight data, body mass index data, mechanical shock data, breathing rate data, and body chemistry data.

15. The information handling system of claim 9 wherein at least one of the one or more processors perform additional actions comprising:
receiving interface parameters from the user that indicate a way in which the user requests to interface with the information handling system;
providing the nutrition intake recommendation to the user according the interface parameters; and
receiving a response from the user according to the interface parameters.

16. The information handling system of claim 15 wherein the interface parameters are selected from the group consisting of a vibration parameter, a swipe parameter, and a tap number parameter.

17. A computer program product stored in a computer readable storage medium, comprising computer program code that, when executed by an information handling system, causes the information handling system to perform actions comprising:
receiving an input data set corresponding to a physical activity of a user;
determining a nutrition intake recommendation based on the input data set; and
providing the nutrition intake recommendation to the user prior to the user completing the physical activity.

18. The computer program product of claim 17 wherein the nutrition intake recommendation includes a nutrition type and a nutrition amount, and wherein the information handling system performs additional actions comprising:
determining a nutrition requirement based on the input data set;
collecting nutrient content data corresponding to nutrition available to the user; and
selecting the nutrition type and the nutrition amount based on comparing the nutrition requirement against the nutrient content data; and
adjusting an amount of the nutrition available to the user based on receiving a response from the user indicating that the user performed the nutrition intake recommendation.

19. The computer program product of claim 17 wherein the physical activity is a course and the input data set corresponds to the course, and wherein, during the physical activity, the information handling system performs additional actions comprising:
identifying an upcoming change in terrain in the course based on the input data set;
determining a point in time that the user will reach the upcoming change in terrain;
computing a recommended consumption time to consume the nutrition intake recommendation based on the point in time; and
notifying the user of the nutrition intake recommendation at the recommended consumption time.

20. The computer program product of claim 17 wherein the information handling system performs additional actions comprising:
receiving interface parameters from the user that indicate a way in which the user requests to interface with the information handling system;
providing the nutrition intake recommendation to the user according the interface parameters; and
receiving a response from the user according to the interface parameters.
